(19) United States
(12) Patent Application Publication
(10) Pub. No.: US 2014/0062034 A1
(43) Pub. Date: Mar. 6, 2014

(54) GAS PATH LEAKAGE SEAL FOR A TURBINE

(71) Applicants: Benjamin Paul LACY, Greer, SC (US); Srikanth Chandrudu KOTTILINGAM, Simpsonville, SC (US); Victor John MORGAN, Simpsonville, SC (US); Neelesh SARAWATE, Niskayuna, NY (US)

(72) Inventors: Benjamin Paul LACY, Greer, SC (US); Srikanth Chandrudu KOTTILINGAM, Simpsonville, SC (US); Victor John MORGAN, Simpsonville, SC (US); Neelesh SARAWATE, Niskayuna, NY (US)

(73) Assignee: General Electric Company, Schenectady, NY (US)

(21) Appl. No.: 13/567,861

(22) Filed: Aug. 6, 2012

(51) Int. Cl. F02C 7/28

(52) U.S. Cl. CPC F02C 7/28
USPC 277/592; 277/591

(57) ABSTRACT

A gas path leakage seal for a turbine includes a flexible manifold having opposed raised edges; at least one cloth seal layer on one side of the manifold between the opposed raised edges; and a filter material covering at least one end of the at least one cloth seal layer.

This invention was made with Government support under Government Contract No. DE-FC26-05NT42643 awarded by the Department of Energy. The Government has certain rights to this invention.

### FIELD OF THE INVENTION

The present invention relates generally to seals, and more particularly to a flexible cloth seal assembly for a gas turbine.

### BACKGROUND OF THE INVENTION

Gas turbine applications include, but are not limited to, power generation equipment and aircraft engines. A gas turbine has a gas path which typically includes, in serial-flow relationship, an air intake (or inlet), a compressor, a combustor, a turbine, and a gas outlet (or exhaust nozzle). Gas leakage, either out of the gas path or into the gas path, from an area of higher pressure to an area of lower pressure is generally undesirable. For example, higher pressure air leakage into the gas path in the turbine area of a gas turbine will lower the efficiency of the gas turbine leading to increased fuel costs. Also, higher pressure air leakage into the combustor area of a gas turbine will require an increase in peak temperature to maintain power level, such increased peak temperature can lead to increased pollution, such as increased NOx production.

Higher pressure air leakage into the gas path occurs through gaps between gas turbine subassemblies such as through gaps between the combustor and the turbine, and air leakage also occurs through gaps between the components that make up a gas turbine subassembly, such as through gaps between nozzle segments. Such components and subassemblies have surfaces of different shapes and suffer from assembly misalignment and undergo vibration. Hot gas path components typically experience different thermal growths. Previous seals include a metal, ceramic, and/or polymer fiber-fabric cloth layer wrapped around a metal, ceramic, and/or polymer foil layer, with the edge of the foil layer protruding beyond the foil layer and bent down to contact a gas turbine member which partially defines the leakage gap and/or with a weld securing the seal to a gas turbine member which partially defines the leakage gap.

### BRIEF SUMMARY OF THE INVENTION

According to an exemplary embodiment of the invention, there is provided a gas path leakage seal for a turbine comprising: a flexible manifold having opposed side edges; at least one cloth seal layer on a surface of the manifold between the opposed side edges; and a filler material covering at least one end of the at least one cloth layer.

According to another exemplary embodiment, there is provided a gas path leakage seal comprising: a flexible manifold having profiled, opposite side edges; a first cloth seal layer on an upper surface of the manifold and a second cloth seal on a lower surface of the manifold, wherein axially-extending gaps are formed between the first and second cloth layers and the profiled, opposite side edges; and a filler material provided over opposite ends of the first cloth layer and the second cloth layer, and over ends of said axially-extending gaps at one or both ends of the manifold.

In still another aspect, the invention provides a gas path leakage seal for a gas path leakage seal for a gas turbine comprising a substantially planar manifold having opposite, substantially hook-shaped side edges; a first cloth seal layer on an upper surface of the manifold and a second cloth seal on a lower surface of the manifold, wherein axially-extending gaps are formed between the first and second cloth layers and the substantially hook-shaped side edges; and a filler material provided over opposite ends of the first cloth layer and the second cloth layer, and in end regions of said axially-extending gaps at one or both ends of the seal.

The invention will now be described in greater detail in connection with the drawings identified below.

### BRIEF DESCRIPTION OF THE DRAWINGS

FIG. 1 is a partial perspective view of a known gas path leakage seal;

FIG. 2 is a perspective view of a gas path leakage seal according to a first exemplary but nonlimiting embodiment;

FIG. 3 is a partial perspective view of a second exemplary but nonlimiting embodiment; and

FIG. 4 is a partial perspective view of a third exemplary but nonlimiting embodiment where a metal shim is first applied to at least one end of the seal.

### DETAILED DESCRIPTION OF THE INVENTION

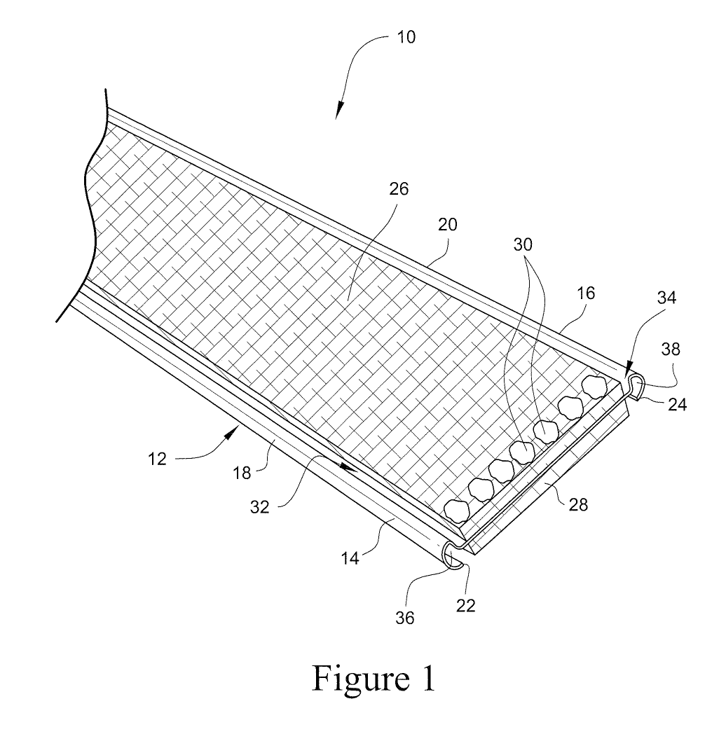

Referring to FIG. 1, a gas path leakage seal 10 includes a manifold 12 that may be in the form of a flexible and generally imperforate sheet formed of, for example, metal, ceramic and/or polymer. In one example, the manifold may be formed of a nickel or cobalt-based super-alloy, such as INCONEL® X750 or HS188. It should be appreciated that the thickness may be dependent on the particular seal application. It should also be appreciated that although the manifold 12 is shown as generally planar, it may be curved depending on the application, for example when installed between combustor casing segments.

The manifold 12 includes opposite, profiled edges 14, 16 having a “shepherd hook” shape with curved surfaces 18, 20 terminating at free edges 22, 24 respectively. It should be appreciated that the edges 14, 16 may have a different configuration, for example a straight configuration. The profiled edges 14, 16 extend along opposite sides of the manifold 12, laterally beyond a first cloth seal layer 26 and a second cloth seal layer 28 applied to the top and bottom surfaces of the manifold (as viewed in the Figure). It will be understood that references to “top” and “bottom” relate to the orientation of the seal as shown in the drawing figures and are not to be considered in any way limiting since the seal may be employed in various orientations in use.

The first and second cloth seal layers 26, 28 may be formed of, for example, metal, ceramic, and/or polymer fibers which have been woven, knitted, or pressed into a layer of fabric. For example, the cloth layers 26, 28 may have a twill weave which floats weft threads over two warp threads and staggers these floats regularly. The form of the layer construction (i.e., woven, knitted, or pressed), the materials for the cloth layers, and the thicknesses of the cloth layers made be determined to meet the wear resistance, flexibility, and sealing requirements of a particular seal application. It should be appreciated that the two cloth layers 26, 28 may be formed of different materials, different layer construction (i.e., woven, knitted, or pressed) and/or have different thicknesses, again depending on the particular seal application.

The first and second cloth seal layers 26, 28 may cover generally the entire opposing (top and bottom) surfaces of the manifold 12. As shown on to FIG. 1, the first and second cloth seal layers 26, 28 may be attached together and to the manifold 12 by a plurality of tack or spot welds 30 or other suitable attachment means. The opposite end of the seal may have a similar configuration.

Leakage at the ends of the gas path leakage seal 10 typically occurs through ends of the first and second cloth seal layers 26, 28 and along gaps 32, 34 formed between the side edges of the upper cloth seal layer 26 and the edges 14, 16, and gaps 36, 38 formed between side edges 14, 16 and the lower cloth layer 28.

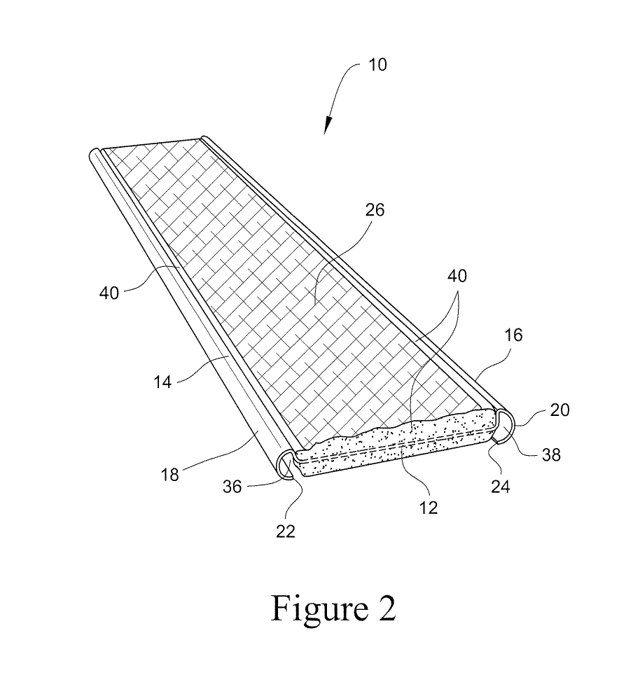

Referring now to FIG. 2, leakage at the ends of the first and second cloth seal layers 26, 28 may be reduced by applying braze filler material 40 over the ends of the first and second seal layers 26, 28 to seal and thus reduce leakage through these paths. The braze filler material 40 may also fill the end regions of gaps 32, 34 (as shown) or fill these gaps along the full length of the seal. Similarly, the braze filler material could fill the ends of the gaps 36, 38 or fill these gaps along the full length of the seal. In the exemplary but nonlimiting embodiment, the braze material is applied by any suitable brazing method, typically in a vacuum chamber. Suitable braze filler alloys include BNi-2, BNi-9, BCo-1, Amdry 915, DF4B, etc. The braze filler can be in the form of paste or foil.

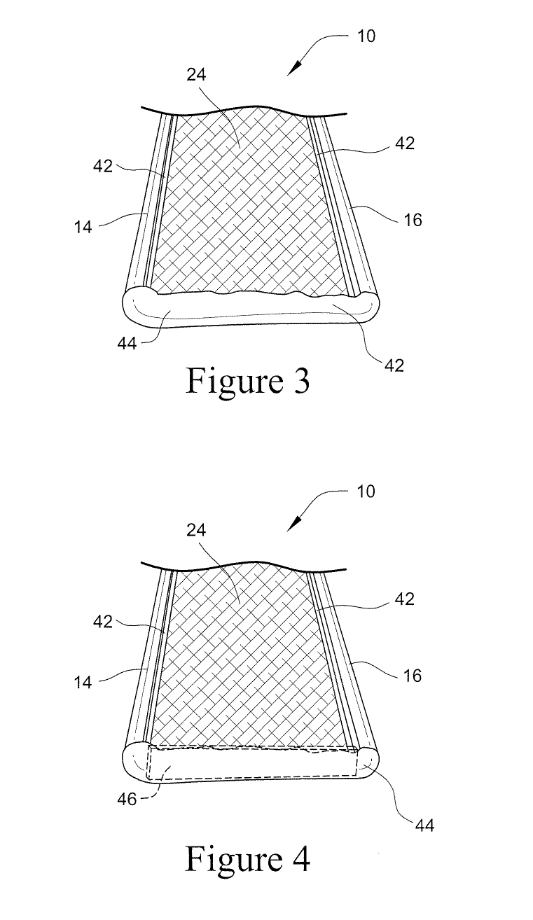

Referring to FIG. 3, according to another exemplary but nonlimiting embodiment, the gas path leakage seal 10 may be provided with weld filler material 42 to cover the ends of the first and second cloth seal layers 26, 28, as well as the ends of the gaps 32, 34, again to reduce leakage at one or both ends of the gas path leakage seal 10. The weld filler material may also fill the ends of the gaps 36, 38 between the cloth layer 28 and the edges 14, 16 of the manifold. Optionally, the filler material could extend along substantially the full length of the seal, within the gaps 32, 34 and 36, 38.

As shown in FIG. 4, the weld filler 42 (or the braze filler) may cover all of the edges of a metal shim 46 provided at one or both ends of the cloth seal layers 26, 28 to thereby seal the leakage path(s) at the end(s) of the seal. It should be appreciated that in an alternative arrangement, the ends of the first and second cloth seal layers 26, 28 may be covered with braze filler as shown in FIG. 2 (instead of the shim 46), with weld filler 42 covering the braze filler. The weld filler (or braze filler) would also cover the ends of the gaps 32, 34 and 36, 38 as described above.

After welding, the weld filler 42 can be surface finished (by grinding or machining) so that the weld filler is flush with the edges of the shim 46 to reduce leakage at the end(s) of the seal 10, including along the edges of the cloth seal layers 26, 28 which may be slightly recessed from the shim edges. The weld filler 42 may also be finished to be flush to the first and second cloth seal layers 26, 28. Typical weld filler metals suitable for use in the embodiments described herein include IN625, H188, HX, N263, etc. Conventional welding processes that may be utilized include GTAW, PAW, Laser and EBW.

Providing brazing and/or welding to the ends of the cloth seal layers of the gas path leakage seal is simpler, easier and more effective than applying shims to the ends of the cloth seal layers and may reduce manufacturing issues. Brazing and/or welding also allows the ends of the cloth seal layers and the profiled edges (hooks) of the manifold to be covered, and the gaps between the profiled edges and the cloth seal layers to be filled. Brazing and/or welding may also improve the wear and flexibility of the gas path leakage seal as compared to the use of shims alone. It will also be appreciated that other suitable filling methods, in addition to braze and weld, may be used to pack and seal the ends and/or side edges of the cloth seal layers.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A gas path leakage seal for a turbine, comprising:
a flexible manifold having opposed side edges;
at least one cloth seal layer on a surface of the manifold between the opposed side edges; and
a filler material covering at least one end of said at least one cloth layer.

2. The gas path leakage seal according to claim 1 and including a second cloth layer on an opposite surface of the manifold, with filler material covering opposite ends of said first and second cloth layers.

3. The gas path leakage seal according to claim 2, wherein the opposite side edges of the manifold are shaped such that gaps are formed between the first and second cloth layers and the opposite side edges of the manifold, and further wherein the filler material fills at least part of the gaps between at least one of the first cloth seal layer and the second cloth seal layer and the manifold.

4. The gas path leakage seal according to claim 2, wherein the opposite side edges of the manifold are shaped such that gaps are formed between the first and second cloth layers and the opposite side edges of the manifold, and further wherein the filler material fills at least part of the gaps between both the first cloth seal layer and the second cloth seal layer and the manifold.

5. The gas path leakage seal according to claim 1, wherein the manifold is substantially planar.

6. The gas path leakage seal according to claim 2, wherein the first cloth layer, the manifold, and the second cloth layer are connected by tack welding or spot welding.

7. The gas path leakage seal according to claim 1, wherein the filler material comprises braze material.

8. The gas path leakage seal according to claim 7 wherein the braze material comprises BNi-2, BNi-9, BCo-1, Amdry 915 or DF4B.

9. The gas path leakage seal according to claim 1, wherein the filler material comprises weld material.

10. The gas path leakage seal according to claim 8 wherein the weld material comprises IN625, H188, HX or N263.

11. The gas path leakage seal according to claim 1 wherein said opposed side edges of said manifold are substantially hook-shaped.

12. A gas path leakage seal, comprising:
a flexible manifold having profiled, opposite side edges;
a first cloth seal layer on an upper surface of the manifold and a second cloth seal on a lower surface of the manifold, wherein axially-extending gaps are formed between the first and second cloth layers and the profiled, opposite side edges; and
a filler material provided over opposite ends of the first cloth layer and the second cloth layer, and over ends of said axially-extending gaps at one or both ends of the manifold.

13. The gas path leakage seal according to claim 12, wherein the filler material comprises braze material.

14. The gas path leakage seal according to claim 13 wherein the braze material comprises BNi-2, BNi-9, BCo-1, Amdry 915 or DF4B.

15. The gas path leakage seal according to claim 12, wherein the filler material comprises weld material.

16. The gas path leakage seal according to claim 15 wherein the weld material comprises IN625, H188, HX or N263.

17. The gas path leakage seal according to claim 12, further comprising a shim provided on at least one of opposite ends of the first and second cloth seal layers, said shim covered with braze or weld material.

18. The gas path leakage seal according to claim 17, wherein the weld or braze material is flush with edges of the shim.

19. A gas path leakage seal for a gas turbine comprising:
a substantially planar manifold having opposite, substantially hook-shaped side edges;
a first cloth seal layer on an upper surface of the manifold and a second cloth seal on a lower surface of the manifold, wherein axially-extending gaps are formed between the first and second cloth layers and the substantially hook-shaped side edges; and
a filler material provided over opposite ends of the first cloth layer and the second cloth layer, and in end regions of said axially-extending gaps at one or both ends of the seal.

20. The gas path leakage seal of claim 19 wherein said filler material comprises braze or weld filler material.
